(19) United States
(12) Patent Application Publication
(10) Pub. No.: US 2026/0230550 A1
(43) Pub. Date: Aug. 6, 2026

(54) SMARTPHONES WITH ADVANCED PHOTOGRAPHY AND TOUCHSCREEN CAPABILITIES

(71) Applicant: Howard Hong-Dough Lee, Bloomfield Hills, MI (US)

(72) Inventor: Howard Hong-Dough Lee, Bloomfield Hills, MI (US)

(21) Appl. No.: 19/046,619

(22) Filed: Feb. 6, 2025

(51) Int. Cl. H04M 1/02; G06F 1/16

(52) U.S. Cl. CPC H04M 1/0266; G06F 1/1643; G06F 1/165; G06F 1/1654; G06F 1/1686; H04M 1/0254; H04M 1/0264; H04M 1/0274; H04M 2250/52

(57) ABSTRACT

Innovative smartphones imparted with advanced photography and/or display capabilities are presented. Comprised are conjugated engaging configurations for enabling exchangeable engaging of a DSLR-quality camera unit to function as external front-facing and/or rear-facing cameras for shooting professional photography, selfies, and self-hosted live broadcasting in various scenarios simultaneously. Also comprised are power distributing configurations, interfacing configurations, and control algorithm for imparting unique functionalities and energy conserving, such as offering an always-on mini display for replacing the conventional status bar showable only together with an actuated touchscreen, eliminating motion-incurred misbehaviors, and conserving battery consumed by various sensors utilized in conventional under-display fingerprint smartphones. Another uniqueness is to split a touchscreen into multiple viewing zones for perfecting photograph taking.

### FIELD OF THE INVENTION

The present invention relates generally to the field of smartphones. More particularly is to make an innovative smartphone engageable with an accessory camera/touchscreen unit for imparting advanced photography and/or display capabilities.

### BACKGROUND OF THE INVENTION

Taking good photographs has been becoming a critical factor for a smartphone to be attractive to buyers. A typical smartphone 110 (seen in FIG. 1) is known to have a front-facing camera 112 for taking selfies, and a rear-facing camera 113 for normal photographs. The front-facing camera 112 is conventionally smaller than the rear-facing camera 113. Followed are some of the inevitable negatives such as duplicative cameras (112 and 113), obstruction of the front-facing camera 112 on display 111 and poor selfie quality.

The obstruction of a selfie camera had been improved by some of other conventional smartphones, for instance a pop-up smartphone 120 seen in FIG. 1 with a selfie camera 122 popped up out of its display 122 and with a rear-facing camera 123. However, still remained is the main concerned negative of duplicative cameras in the pop-up smartphone 120.

The duplicative cameras had been taken care by a conventional flip-out smartphone 130 with a flip-out camera functioning as a rear camera 131 and as a selfie when flipping out along an axis 134 parallel with the top side face of the conventional flip-out smartphone 130.

Another approach to resolve the duplicative cameras can be seen in an existed foldable smartphone 140, by having a flexible front-facing display 141 and a smaller rear display 146. The smaller rear display 146 enables a user to take a selfie using a rear-facing camera 143. However, the dual displays inevitably incur another negative of cost. Another existed foldable smartphone 150 has a foldable display 151, a front-facing camera 152 for taking selfies and a rear-facing camera 153 for taking regular photographs, which is deemed by Applicant as another typical smartphone.

Based on the short background summaries hereinabove, Applicant's reviews and analyses on numerous models of the existed smartphones can be categorized as follows: (i) a first type of conventional typical smartphones each having a front-facing camera a rear-facing camera; (ii) a second type of conventional pop-up smartphones each having a front-facing camera hidden under its display for selfies, and a rear-facing camera; (iii) a third type of conventional flip-out smartphones each having a single camera capable of flipping out for selfies in addition to as its rear-facing camera for taking regular photographs; (iv) a fourth type of conventional foldable smartphones each having a front-facing camera a rear-facing camera without achieving any improvement, except for its bendable display.

Applicant's summaries hereinabove also reveal the fact that the most effective conventional practice to resolve the duplicative cameras is to enable a camera for instance 132 and 133 seen in FIG. 1 capable of rotating along an axis 134 parallel with the adjacent face of its host smartphone. However, this conventional practice will inevitably encounter an unsurpassable obstacle or dilemma against the commonly-adopted trend of minimizing the thickness of a smartphone.

Accordingly, Applicant's summaries hereinabove further reveal the need of evolving a novel and unexpected structural configuration for overcoming the concerned negatives described previously and for achieving advanced photography.

Based on analyzing the third type of conventional flip-out smartphones, in addition to searching on Google, Applicant have further searched the prior art available in the USPTO. The advanced search based on the keywords of selfie AND camera AND smartphone AND “detachable camera” gives 6 references U.S. Pat. No. 11,431,897 B1, US 20190250677, U.S. Pat. No. 10,579,108 B2, US 20170369164, US 20170369164, US 20160006920 A1, and U.S. Pat. No. 10,200,583 B2.

Further, the advanced search based on the keywords of smartphone AND “rotatable camera” AND lens AND parallel AND “optical axis” gives 19 references. One of the most pertinent prior art is U.S. Pat. No. 11,659,074 B2, which can be categorized to the third type of conventional flip-out smartphones. In addition to the conventional flip-out mechanism, Kinouchi employs a two-part pivot for further rotating. The lenses in any flip-out camera basically have a lens plane parallel with its host display, and an optical axis perpendicular to its display when functioning as a rear-facing camera in its normal position. In essence, a flip-out camera rotates about a line parallel with its adjacent face. Accordingly, the present invention has advanced photography qualities by overcoming the prior art cited hereinabove, without involving the rotation approach relied upon by the conventional flip-out smartphones.

### SUMMARY OF THE INVENTION

Accordingly, a first primary preferred embodiment of the present invention is to provide an upgradable smartphone with advanced photography capabilities, by replacing a conventional built-in camera with an accessory camera unit, comprising: (a) an accessory camera unit comprising at least one camera IC module each with camera lenses having an optical axis; (b) a phone housing assembled with a touchscreen having a display plane; and (c) an upholding structure rendered engageable to the accessory camera unit and to the phone housing structure for upholding the external camera module in a perpendicular manner with respect to a side of the phone housing, so as to place the optical axis in an orientation generally perpendicular to the display plane for the accessory camera unit to function selectively as at least one front-facing and/or rear-facing camera. The accessory camera unit is rendered to have a longer side for situating the optical axis aligned in parallel, so as to allow the camera lenses to have longer focal lengths and/or a larger lens sizes.

A second primary preferred embodiment is to provide an upgradable smartphone and an accessory camera unit rendered exchangeable to each other for providing advanced and professional photography and video functionalities in performing self-hosted live broadcasting, which are not available in any conventional smartphone. Connectors/ports/adapters are recited to have conjugated conductive pins/legs/buses engaged for establishing operating power and circuit connection to the accessory camera unit.

A third primary preferred embodiment is to provide a screen-expandable smartphones. The screen-expandable smartphone is rendered to have at least one display compartment for storing a rollable touchscreen. Alternatively implemented is an accessory touchscreen unit containing an external display IC module and a port/connector engageable by a pocket-sized smartphone with a PMIC rendered capable of distributing operating power through the port/connector to the external display IC module, while deactuating the built-in display on the pocket-sized smartphone.

A fourth primary preferred embodiment is to provide an advanced camera unit having multiple front-facing and rear-facing camera modules for (i) taking multiple photos including self-portraits and rear images in normal, macro, wide angle, ultrawide angle, and/or telephoto modes simultaneously; (ii) combining the front and the rear images in one frame in a desirable configuration, so that a self-portrait is accompanied with the surrounding scenery simultaneously in various modes. Further detailed are power distributing and a control algorithm for (i) actuating a first (or operating) power supply and a second (or keep-alive) power supply respectively to a main touchscreen and a mini display, and (ii) deactuating the first power supply to the main touchscreen, while retaining the second power supply for the mini display to stay alive; so as to extend a smartphone with advanced photography and display capabilities.

A fifth primary preferred embodiment is to provide a U-shaped connector engageable with a horizontal port situated parallel with a side of a smartphone, which has a supporting column for stably upholding an accessory camera unit with advanced photography capabilities.

A sixth primary preferred embodiment facilitates engaging and holding, by reciting (a) a surface-type port and connector adapted (i) to have an engaging surface aligned parallel to a side of a smartphone and generally perpendicular to the main touchscreen, and (ii) to have a groove-and-tongue structure for directional conjugated engaging and holding; and (b) the conductive pins are arranged in a configuration selected from the group consisting of (i) a first layout, arranged in a single row; (ii) a second layout, arranged on the engaging surface alternately in at least two rows facing a similar direction, and (iii) a third layout, placed on a surface generally perpendicular to the engaging surface, and (iv) any of their combinations.

A seventh primary preferred embodiment is to impart a smartphone with advanced display capabilities by (a) providing a first power supply to a main touchscreen and a second power supply to a mini display; (b) deactuating the main touchscreen, while leaving the mini display active; and (c) rendering the mini display capable of actuating the main touchscreen, only receiving a designated touching signal from the mini display or from a power and/or a volume button.

An eighth primary preferred embodiment recites an operating method for extending advanced photography and/or display capabilities to a smartphone having a battery and a mainboard situated thereon a PMIC and a MCU, by a control algorithm executable by the MCU for instructing the PMIC to perform steps of (a) actuating the first power supply to the main touchscreen and/or the accessory camera unit, and the second power supply to the mini display, and (b) deactuating the first power supply to the main touchscreen and/or the accessory camera unit, while retaining the second power supply alive to the mini display; so as to extend the smartphone with advanced photography and/or display capabilities.

### BRIEF DESCRIPTION OF THE DRAWINGS

FIG. 1 categorizes the conventional smartphones into four types based on camera capabilities1.

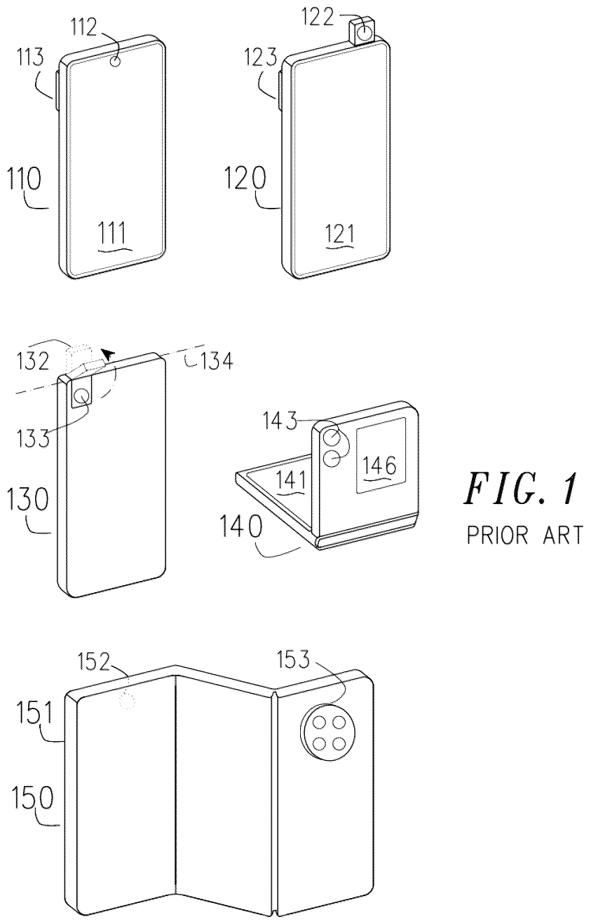

FIG. 2 depicts an upgradable smartphone having camera modules each situated in a separated structure having a rotation axis vertical to the adjacent face of the smartphone structure, in accordance with a first primary preferred embodiment of the present invention.

FIG. 3 shows camera modules seen in FIG. 2 are rotated about respective connectors for functioning as front-facing and rear-facing cameras.

FIG. 4 is an upgradable smartphone with a detachable and rotatable camera module, in accordance with a second primary preferred embodiment.

FIG. 5 depicts cross-sectional views of 5A referring to a port rendered on a top side of an exchangeable smartphone, and 5B showing a front-facing camera module with male connector.

FIG. 6 depicts cross-sectional views of 6A referring to a port rendered stationarily on a top side of an exchangeable smartphone, and of 6B showing an exchangeable camera module with a male adapter rendered rotatable.

FIG. 7 is a screen-expandable smartphone with views of 7A showing one rollable display fully unrolled, 7B depicting the side view of a side face with a display compartment enclosed, and 7C showing the side face opened, in accordance with a third primary preferred embodiment.

FIG. 8 is an extended case for retaining the unrolled display depicted in FIG. 7 to become a tablet.

FIG. 9 is a block diagram of an exchangeable touchscreen to be engaged in circuit connection with a smartphone, in accordance with the third and a fourth primary preferred embodiments.

FIG. 10 is a mixed diagram showing perceptive and block views of a non-camera smartphone engageable with an accessory camera unit, in accordance with the fourth primary preferred embodiment.

FIG. 11 depicts a horizontal port situated parallel with a top side of a smartphone, in a back view 11A and a top cross-sectional view of the horizontal port, in accordance with a fifth primary preferred embodiment.

FIG. 12 is a camera module with a U-shaped connector, showing a front view 12A and a side view 12B, in accordance with the fifth primary preferred embodiment.

FIG. 13 shows the snap-on mechanism of a surface-type port 13A and connector 13B, in accordance with a sixth primary preferred embodiment.

FIG. 14 is a simplified block diagram of a smartphone comprising keep-alive power to a mini display and operating power to a main display, in accordance with a seven primary preferred embodiment.

FIG. 15 is a flowchart reciting the method for controlling a front-facing camera and a rear camera to take photographs simultaneously, so that a portrait is taken with its front-facing surrounding scenery in real life, in accordance with an eighth primary preferred embodiment.

### DETAILED DESCRIPTION OF THE PREFERRED EMBODIMENT

### Some Definitions on Exchangeable Smartphones and on Ports and Connectors

The 1word of “exchangeable” in the present invention is generally defined as separable, detachable, replaceable, combinable, integrable and/or rotatable, for simplifying illustrations of the present invention. The word of “smartphones” generally refer to all portable, handheld devices, tablets, mobile or cellular phones capable of transmitting information wirelessly such as through a data provider, Wi-Fi, Bluetooth, NearLink or wireless communication. Accordingly, an exchangeable smartphone hereinafter is refined as a smartphone with its structural configuration rendered with exchangeable capabilities generally defined hereinabove.

The words of “ports” and “connectors” refer generally to connecting structures capable of being engaged with each other, although the drawings and descriptions generally recite the ports and the connectors in a female shape and in a male shape respectively for the purpose of giving simplified illustrations. Consequently, the ports and the connectors may also refer to male adapters and the connectors to female adapters, as long as they have a conjugated configuration for engaging with each other.

### Camera Rotation Axis Vertical to Adjacent Face

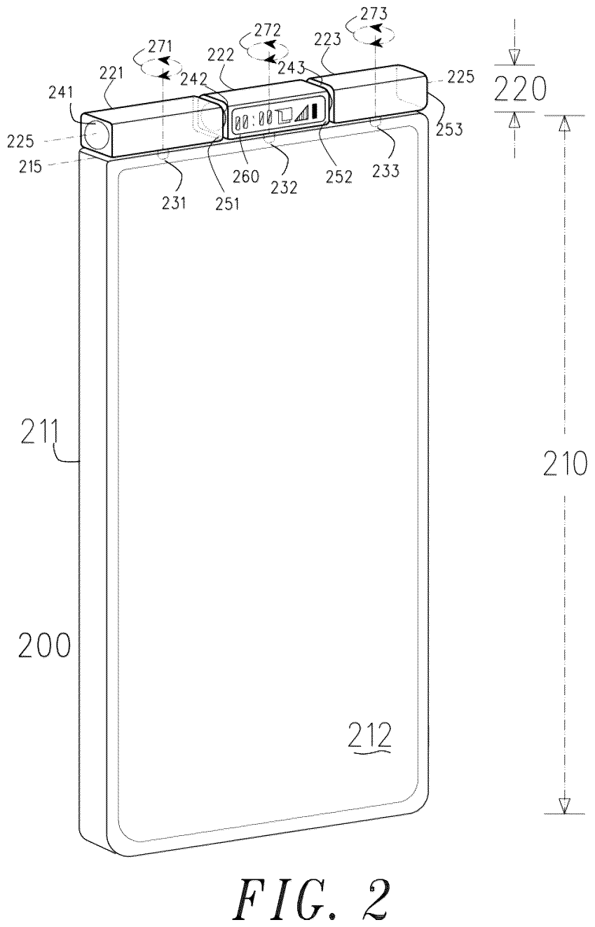

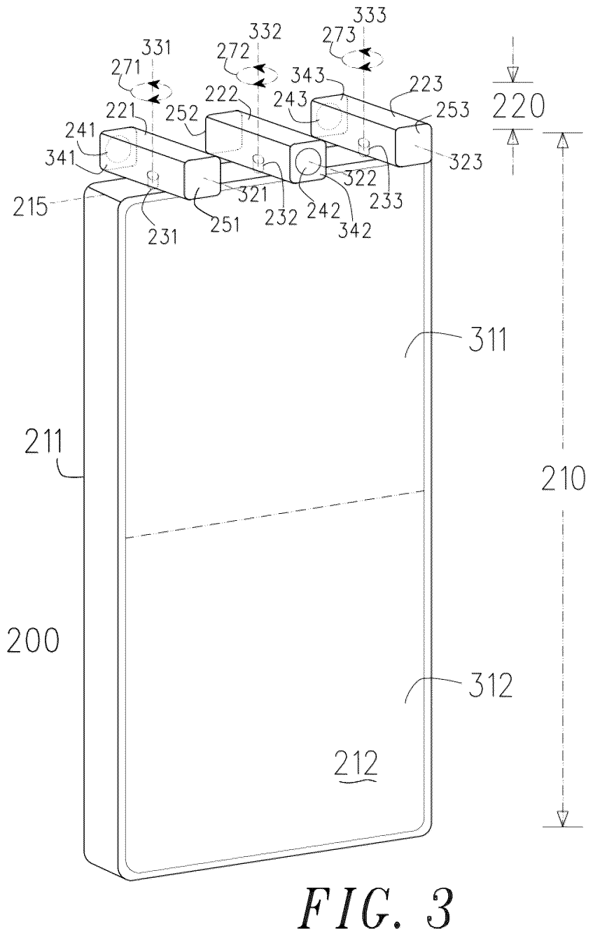

Described herein is a first primary preferred embodiment exemplified by an upgradable smartphone 200 with advanced photography capabilities as depicted in FIG. 2, having a plurality of camera modules each rotatable about a respective rotation axis (or rotation connector) generally vertical to the adjacent top face (as depicted) or side of upgradable smartphone 200. The side face also refers to a side of the midframe of upgradable smartphone 200. The midframe also is referred to a structural housing. The adjacent face is normally in a horizontal plane when upgradable smartphone 200 is in use for taking a photo, also as depicted in FIG. 3.

In other words, the rotation planes (271, 272, and 273 seen in FIGS. 2 and 3) of optical axes (225 seen in FIG. 2, and 321, 322 and 323 in FIG. 3) are always parallel with the adjacent face (or the top side) 215 of upgradable smartphone 200, in complete contrast to the rotation plane of the optical axis of a flip-out camera is always perpendicular to its adjacent face. Further completely contrast is the conventional flip-out camera rotatable about a rotation axis parallel with its adjacent face.

In detail, FIG. 2 depicts upgradable smartphone 200 having a first structure 210 with popular dimensions of 160.3×75×8.1 mm (6.31×2.95×0.32 in) as its structural housing 211 for assembling a 6.67-inch main display 212 with touchable functionalities on surface. Underneath main display 212 is a battery-powered mainboard (not seen in FIG. 2) for interfacing with main display 212. Further provided is a second structure 220 exchangeable and rotatable to first structure 210.

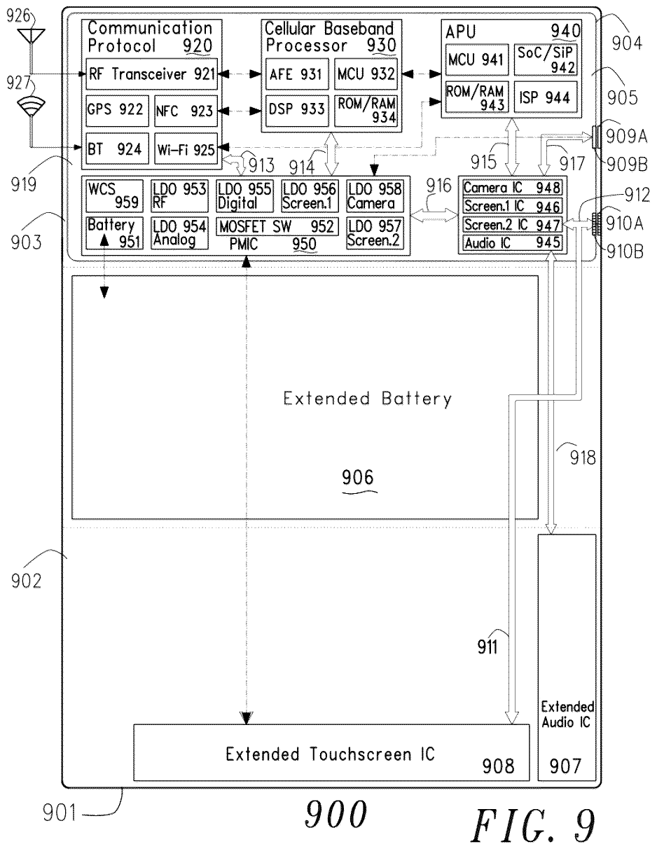

Second structure 220 is represented by three camera modules 221, 222, and 223 each also referred as a respective structural housing situated on adjacent face 215 of upgradable smartphone 200. Camera modules 221, 222, and 223 each comprises a lens module 241, 242, or 243, an image sensor (made up of photosites for catching light) such as CCD (charge coupled device) or CMOS (complementary metal oxide semiconductor) 251, 252, or 253, and a rotation connector 231, 232, or 233, or respective camera rotation axis 331, 332, or 333 shown in FIG. 3. Further concealed in each camera module are a voice coil motor (VCM) for controlling lens motion to adjust lens focal length, an infrared ray (IR) filter for filtering light wavelengths invisible to human eyes, and a flexible printed circuit (FPC) or a flexible flat cable/circuit (FFC) bus or ribbon providing linkage by connecting the signals sensed by image sensor 251, 252, or 253 to a control circuit through a respective rotation connector 231, 232, or 233 to the battery-powered mainboard (not shown in FIG. 2 as covered by main display 212, but elaborated in FIG. 9) assembled in first structure 210.

As depicted, rotation connectors 231, 232, and 233 each essentially is a supporting column for upholding camera modules 221-223 respectively. Camera module 222 has a mini display 260 showing a status bar with time, messages, mobile network, Wi-Fi, and battery level, for replacing the status bar and the front-facing camera blocking the view of main display 212. Mini display 260 consumes minor battery and may be kept on always, while main display 212 stays in an energy-saving or even power-off mode.

Rotation connector 232 is embedded or printed with circuit lines or a flexible printed circuit ribbon functioning as a camera serial interface bus (CSIB) for establishing circuit connection (including serial transmission of data, control signals, camera parameter configurations and settings, clock signals, and power supply) with image sensor 252, the battery-powered mainboard, and mini display 260. Rotation connectors 231 and 233 are also equipped with CSIB or embedded circuit lines, but mini display 260 may be interfaced for showing the status bar of the mainboard.

Accordingly, the circuit connection allows (i) the interface between the mainboard and image sensor 252 to be proceeded, (ii) an image collected therefrom be transmitted to the mainboard, and (iii) the image be displayed on main display 212.

Camera modules 221, 222, and 223 each is rotatable about a respective rotation axis represented by a rotation connector 231, 232, or 233 situated vertically to the adjacent face 215 of upgradable smartphone 200, in complete contrast to the rotation axis of any conventional flip-out camera that has to be parallel with the adjacent face of its host structure.

Kinouchi's mechanism is identical to the other conventional flip-out smartphones, his flip-out camera has a rotation axis also parallel with the adjacent face of Kinouchi's terminal body. Kinouchi further relies on another pivot axis for a second rotation, which is absent in Applicant's present embodiment.

Accordingly, the flip-out mechanism including Kinouchi further restricts camera construction to an even shorter size due to additional structures required, as compared to the first type of conventional typical smartphones each with a camera module simply concealed underneath the display without Kinouchi's additional structures.

The thickness of upgradable smartphone 200 in FIG. 2 is depicted as 8.1 mm. The latest trend of smartphone evolution is to reduce towards 7 mm. Accordingly, there isn't much room for a conventional smartphone to increase its camera focal length even by protruding out a few mm, or by oppositely increasing smartphone's thickness.

Due to the restricted thickness, the vast majority of smartphone cameras have a fixed and short focal length as well as a fixed aperture. A typical smartphone camera lens has a focal length around 3-4 mm, often expressed as being equivalent to a 28-35 mm lens on a digital single-lens reflex (DSLR) camera. Furthermore, in contrast to the DSLR, smartphone's aperture is unchangeable for controlling more or less light in.

### Advanced Photography Capabilities by Configuring Camera Rotation Axis Vertical to Adjacent Face

FIG. 2 depicts three camera modules 221, 222, and 223 each with a maximal length of 24 mm aligning on a common optical axis 225 and on top of adjacent face 215, based on structural housing 211. FIG. 3 shows that camera module 222 is rotated about its axis 332 or connector 232 to function as a front-facing camera for taking advanced selfies, while camera modules 221 and 223 are rotated about respective axes 331 and 333 as rear-facing cameras with ultrawide angle, macro and/or telephoto modes for taking regular photographs separately or simultaneously.

When smartphone is in use for taking photos, adjacent face 215 is essentially in a horizontal plane, and rotation connectors 231-233 or camera rotation axes 331-333 are generally vertical to adjacent face 215.

In order to take selfies and normal photographs simultaneously, instructions are provided to an applications processing unit (to be further elaborated in FIG. 9) for (i) instructing camera IC to control the lens motions of VCM 341, 342, and 343 simultaneously; (ii) splitting main display 212 into a first image zone 311 for displaying a front-camera image and a second image zone 312 for rear-camera images; (iii) taking a front image and at least two rear images in normal, macro, wide angle, ultrawide angle, and/or telephoto modes simultaneously; (iv) saving the images; (v) combining the images in one frame in a desirable configuration; (vi) applying AI technology to automatically extract a self-portrait from the front image; and (vii) applying AI technology to integrate the extracted self-portrait in the surrounding rear images in various modes.

As depicted in FIG. 3, the size of lens modules 241, 242, and 243 is 6 mm. In contrast to the present invention, the lens and the image sensor sizes of any conventional built-in mobile or a flip-out camera have to be very small because of thickness being severely restricted as compared to a full-frame DSLR camera. A lens diameter is known to be the most important factor in setting image resolution and in controlling light gathering. The larger the lenses, the higher resolution as well as the more light-gathering will be. Typical DSLR camera lenses range from around 10 to 50 mm, or even larger, while mobile cameras are much smaller, usually around 2 mm in diameter due to the severely restricted smartphone thickness and space.

The present embodiment shown in FIGS. 2 and 3 thus provides an ample space especially in thickness for increasing camera lens sizes much beyond the conventional 2 mm diameter, and for adding the features of an adjustable F-stop or aperture. The larger the diameter, the lower F-stop and the brighter the light.

While three camera modules 221, 222 and 223 are depicted in FIGS. 2 and 3 by way of illustration and example, a single camera module with any combination of multiple lenses (ultra-wide, wide, macro, fisheye, or telephoto lenses) or even a full-frame DSLR interchangeable and/or with mini display 260 will become implementable.

Lens modules 241, 242, and 243 each has a plurality of lenses for providing the optical zoom function, replacing a periscope camera especially designed by taking up space sideways inside a conventional smartphone in the expense of sacrificing some components and features. Due to the ample space, it is also possible for lens module 241, 242, or 243 to be configured in accordance with the mechanism of Digital Single Lens Reflex.

In summary, the first primary preferred embodiment provides an upgradable smartphone with advanced photography capabilities, by replacing a conventional built-in camera with an accessory camera unit, comprising: (a) an accessory camera unit comprising at least one camera IC module each with camera lenses having an optical axis; (b) a phone housing assembled with a touchscreen having a display plane; and (c) an upholding structure rendered engageable to the accessory camera unit and to the phone housing structure for upholding the external camera module in a perpendicular manner with respect to a side of the phone housing, so as to place the optical axis in an orientation generally perpendicular to the display plane for the accessory camera unit to function selectively as at least one front-facing and/or rear-facing camera. The accessory camera unit is rendered to have a longer side for situating the optical axis aligned in parallel, so as to allow the camera lenses to have longer focal lengths and/or a larger lens sizes.

### Upgradable Camera Modules for Advanced and Affordable Live Broadcasting

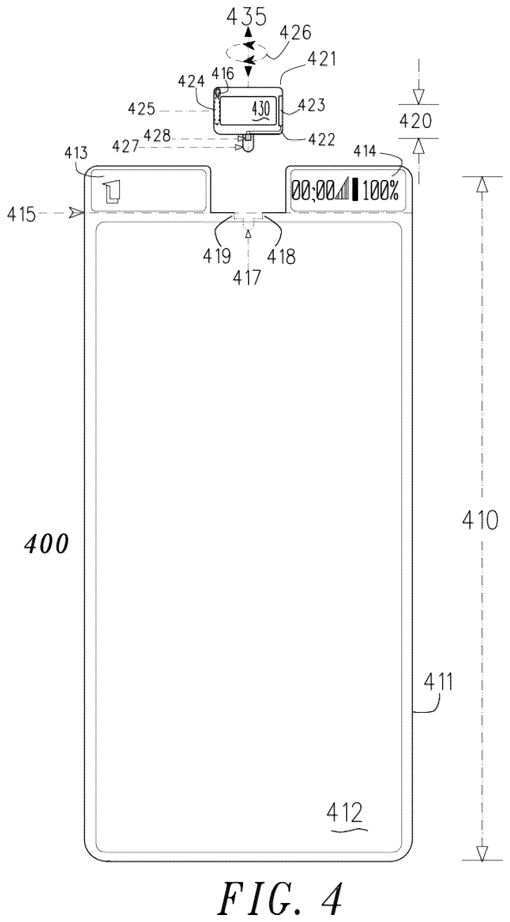

The recent advent of short video apps has spawned millions of people devoting their careers for live broadcasting using the abundantly available smartphones. While offering a large display for showing images, the conventional smartphones suffer from lack of quality front-facing cameras. In accordance with a second primary preferred embodiment of the present invention, embodied in FIGS. 4-6 and 10 are the camera modules of the present invention rendered exchangeable and/or rotatable for providing advanced and professional photography functionalities, which are not available to any conventional smartphone.

Upgradable smartphone 400 has a first structure 410 comprising a housing 411 and a second structure 420 comprising an exchangeable camera module 421. Preferably, First structure 410 contains no built-in camera module. Exchangeable camera module 421 becomes replaceable, functioning as an accessory capable of being upgraded or exchanged for taking photos in various advanced photographic scenarios or modes simultaneously.

The front surface of housing 411 is enclosed by a main display 412. Underneath main display 412 concealed are a mainboard, a battery, and FFC buses (not shown) providing linkages and circuit connections to main display 412 and to a front-facing camera port connector 418 and a rear-facing camera port connector 419 having female conductive pins. Port (or female socket) 417 is rendered for the accommodation of male rotation connector 427 having a rotation axis 435. Along with the direction of rotation axis 435, camera module 421 can be interlocked into or detached from first structure 411.

The interactivity of main display 412 is controlled by a power management system for saving energy, when idled. In the prior art, a single display is also conventionally used to show a status bar, which is also turned off simultaneously. In contrast, depicted in FIG. 4 are a first mini display 413 for displaying messages, notifications, weather, or live news streams, and a second mini display 414 for displaying time, mobile network, Wi-Fi, or battery level percentage. Both first and second mini displays 413 and 414 may be integrated with main display 412 into one piece of screen, but have a separate display zone or a power circuit for staying alive all the time.

Adjacent to male rotation connector 427 is a male adapter 428 that has a corresponding number of conductive pins physically connected with a camera FFC bus 422 to an image sensor 423. Camera FFC bus 422 interfaces image sensor 423 preferably by a MIPI (Mobile Industry Processor Interface) CSI-2 (Camera Serial Interface) protocol in a 15- or 22-pin MIPI connector for instance.

Also situated on camera module 421 are a lens module 424 having an optical axis 425, a flash 416, and a third mini display 430. Lens module 421 will become a front-facing or a rear-facing camera, when male adapter 428 is plugged into either port connector 418 or 419, respectively. On the other hand, plugged into the depicted position, camera module 421 will allow third mini display 430 to function as another always-on LED/OLED screen. Third display 430 as depicts in FIG. 4 is facing the same direction with main display 412, first mini display 413 and second mini display 413.

Accordingly, optical axis 425 has a rotation plane 426 generally parallel with adjacent face 415 (which is perpendicular to the plane of main display 412) on first structure 410. In other words, rotation axis 435 or male rotation connector 427 is generally vertical to adjacent face 415 on first structure 410. Both are in complete contrast to the mechanism of the conventional flip-out cameras including Kinouchi's teaching.

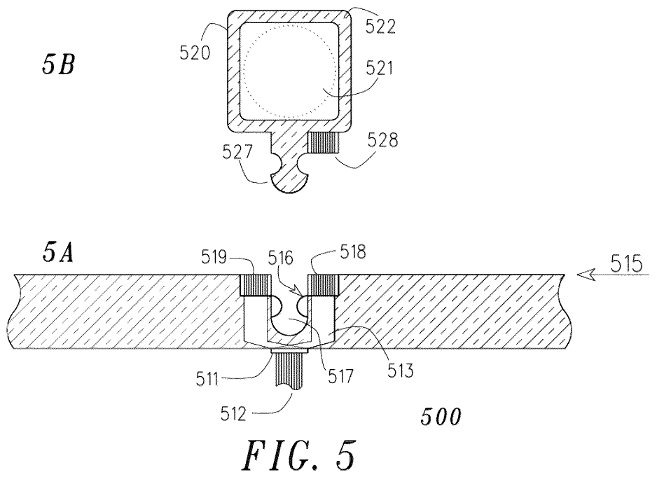

Depicted in FIG. 5 are cross-sectional views of a smartphone 500, detailing a port connector and a front-facing camera module having a male rotation connector, shown as 5A and 5B, respectively.

Shown in 5A of FIG. 5 is a cross-sectional view of adjacent face 515, which corresponds to adjacent face 415 on first structure 410 seen in FIG. 4. As depicted, the cross-sectional view of adjacent face 515 has no through holes for achieving ip68 and ip69 (ingress protection). Underneath adjacent face 515 is a connector 511 and an internal FFC ribbon 512 and an embedded bus 513 connected to port connectors 518 and 519 having conductive legs as depicted for providing internal linkages by a MIPI CSI-2 protocol to an internal mainboard. Adjacent face 515 is rendered in a manner to have a port 517, spring-holding mechanism 516, in addition to port connectors 518 and 519 each having female conductive pins/legs in circuit connection with internal FFC ribbon 512.

Also seen in FIG. 5 is 5B representing the cross-sectional view of camera module 520 currently rotated to function as a front-facing camera, comprising a lens module 521, a VCM 522 for controlling the motion of lens module 521, and a male connector 527 shaped in a manner to be fitted into port 517 and tightly held by spring-holding mechanism 516. Lens module 521 will function as a front-facing camera (as depicted in 5B) or a rear-facing camera, when a male adapter 528 depicted with conductive legs is plugged into either port connector 518 or 519 for establishing operating power and circuit connection, respectively.

A camera lens size of 6 mm in diameter is depicted in 5 B, which is much larger than the conventional mobile camera lenses about 2 mm. Accordingly, a camera module shown in 5B based on the second primary preferred embodiment enables lenses to be larger than 6 mm or in sizes for making digital single-lens reflex (DSLR) cameras.

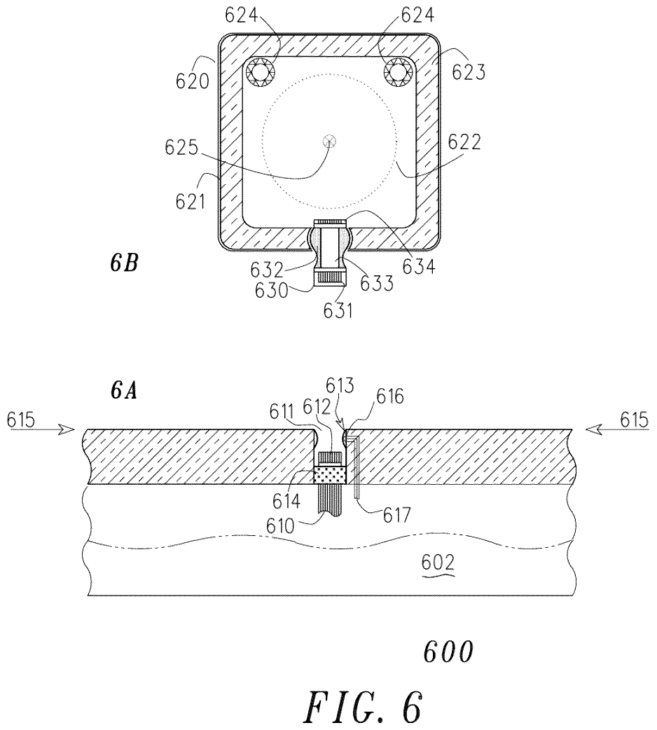

FIG. 6 is another variation of the first and the second primary preferred embodiment, showing a smartphone 600 especially detailed with the cross-sectional views of 6A for an adjacent face 615 (on a first structure) and of 6B for an exchangeable camera module 620 (on a second structure). Different from FIG. 5, FIG. 6 has a single and stationary port connector on adjacent face and a camera module with a single rotatable male connector.

Depicted in 6A is the cross-sectional view of adjacent face 615 having a plane vertical to the plane of a main display 602. The cross-sectional view of adjacent face 615, which may also be implemented as the structural configuration for first structure 210 or 310 seen in FIG. 2 or 3. Adjacent face 615 is rendered to have a port 611, a spring-holding mechanism 613, a port connector 612 having female conductive pins/legs in circuit connection with an internal FFC ribbon 610 enclosed by a sealer 614 for ip68 and ip69.

Also depicted in 6A is a waterproof trigger microswitch 616. When spring-holding mechanism 613 is forced or released, waterproof trigger microswitch 616 selectively actuates or deactuates a power draw from power bus 617. The use of waterproof trigger microswitch 616 thus eliminates the presence of keep-alive power always relied upon by a NMOS or PMOS switch.

Shown in 6B of FIG. 6 is the cross-sectional view of camera module 620 currently positioned as a front-facing camera, comprising a camera housing 621, a lens module 622, a VCM 623 for controlling the motion of lens module 622, two flashes or autothyristors 624, and a male connector 630 shaped in a manner to be fitted into port connector 612 and tightly held by spring-holding mechanism 613. Lens module 622 will function as a front-facing camera currently depicted in 6B, when male adapter 631 is plugged in and engaged with port connector 612 for establishing circuit connection.

Further depicted in 6B are a pivot 632 and a FFC channel 633. Pivot 632 provides some degrees of rotational capability for camera module 620 rotatable about male connector 630 to become a front-facing camera (shown in 6B) or a rear-facing camera. FFC channel 633 connects to a camera FFC connector 634 that is freely situated so as to allow camera module 620 rotatable about male connector 630 when fixedly plugged into port connector 611.

Port connector 612 and male adapter 631 may be represented by a USB-OP female port and a USB-OP male plug, or any other surface mount connector in a condensed form and size capable of carrying high-resolution video and audio signals. USB-OP refers to a USB style connector with a protocol of providing operating power designated for powering external camera modules and extended touchscreens.

As depicted in 6B, camera module 620 shown as a front-facing camera has a lens module 622 with an optical axis 625, which is currently perpendicular to main display 602 of smartphone 600. While male connector 630 is stationary when locked into port connector 611, camera module 620 and optical axis 625 are rotatable about pivot 632.

The rotation plane of camera module 620 or optical axis 625 is generally parallel with adjacent face 615 (i.e., the top side of smartphone 600), but perpendicular to smartphone display 602. In complete contrast, the rotation plane of the optical axis of a flip-out camera is always perpendicular to its adjacent face.

While FIGS. 5 and 6 each depicts the direct engaging of a port on a first structure and a male connector on a second structure, it is understood that both first and second structures may be rendered to have female ports engageable by a third structure that is a male-to-male connector for establishing circuit connection and for stably supporting the second structure (i.e., camera modules).

In summary, FIGS. 4-6 depict the second primary preferred embodiment, reciting accessory camera units rendered exchangeable or upgradable for imparting advanced and professional photography and video functionalities especially in performing self-hosted live broadcasting, which are not available to any conventional smartphone. Connectors/ports/adapters are recited to have conjugated conductive pins/legs/buses engaged for establishing operating power and circuit connection to the accessory camera units.

### Smartphones With Expended/extended Touchscreen Capabilities

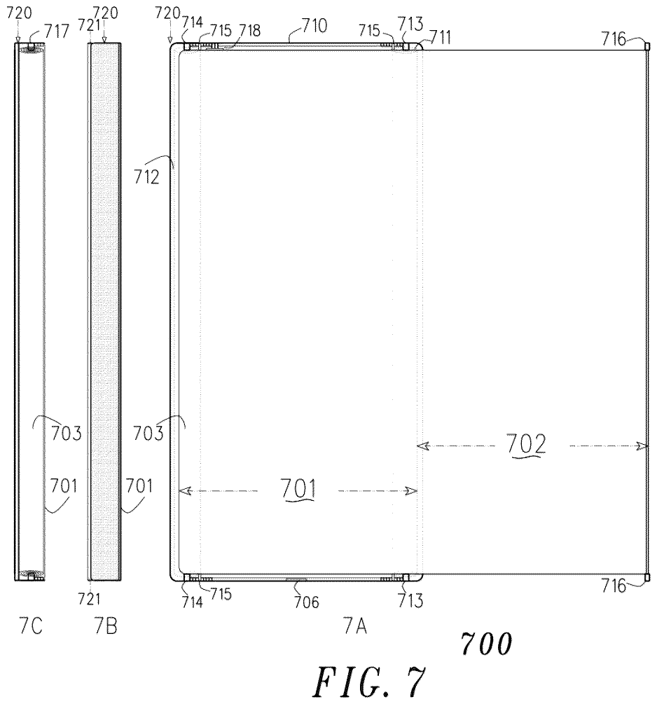

Depicted in FIGS. 7-9 are a third primary preferred embodiment. FIG. 7 shows a screen-expandable smartphone 700 in a perceptive view with a rolled-up size of 160.3×75×8.1 mm (6.31×2.95×0.32 in), which can be fully unrolled or extended to a size of 160.3×225×8.1 mm (6.31×7.85×0.32 in). Screen-expandable smartphone 700 essentially has an expendable/extendable or unrollable touchscreen into a tablet.

In detail, screen-expandable smartphone 700 comprises a structure 710 with its front surface covered by a stationary display 701, as depicted in 7A. Equipped in structure 710 are two display compartments 711 and 712, for storing a first rollable display 702 (unrolled as seen in 7A) and a second rollable display 703 (currently rolled-up and retained in compartment 712 as depicted in 7A, 7B and 7C).

Structure 710 has two pairs of engaging grooves 713 and 714. First and second rollable displays 702 and 703 have rolling shafts 716 (seen in 7A) and 717 (in 7C) respectively, functioning as a mechanism for extending/unrolling out of or retrieving/rolling into respective display compartment 711 or 712. Rollable displays 702 and 703 with their respective rolling shafts 716 and 717 are rollable or retrievable into display compartments 711 and 712, when engaged into engaging grooves 713 and 714. Gear modules 715 and a motor 718 may be further provided to facilitate the rolling of rolling shafts 716 and 717 and thus their respective rollable displays 702 and 703.

Further comprised in structure 710 is a USB-OP 706 defined as Operating Power Mode allowing a draw of operating power sufficiently designated for operation of accessory camera units and extended external touchscreens, which is also capable of establishing a high-speed camera serial interface with a camera module of the present invention to be further elaborated in FIG. 9 in conjunction with a power management integrated circuit.

Depicted in 7B is the side view of side face 720 seen in 7A with display compartment 712 enclosed. Also depicted in 7B are hinges 721 rendering side face 720 openable. 7C shows that side face 720 is currently opened and ready for rollable display 703 to be unrolled out and further extended the size of the touchscreen from stationary display 701 and unrolled display 702.

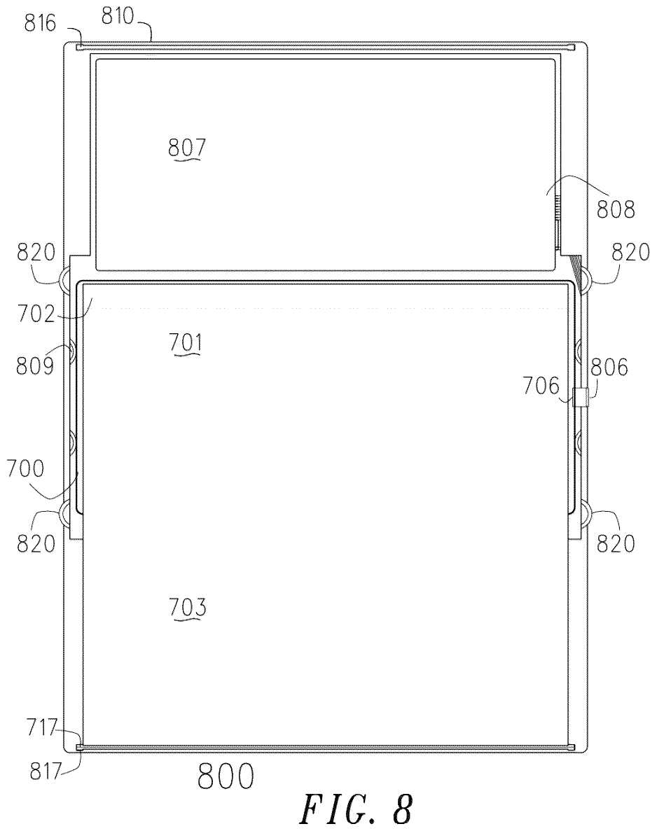

FIG. 8 is an extended case or housing structure 800 for retaining rollable displays 702 and 703 of screen-expandable smartphone 700 seen in FIG. 7, so as to function as a tablet. Extended case 800 has a supporting structure 810, holding mechanisms 809, two pairs of locking grooves 816 and 817, an extended battery 807, a power cable 808, and a USB-OP connector 806 for establishing power connection between USB-OP 706 and power cable 808. Holding mechanisms 809 retain screen-expandable smartphone 700. Rolling shafts 717 of screen-expandable smartphone 700 is engaged into locking grooves 817. Once rolling shafts 716 of rollable display 702 are extended and locked into locking grooves 816, screen-expandable smartphone 700 having the support of extended case 800 will be transformed into a tablet.

Supporting structure 810 is rendered to have two pairs of hinges 820 and to be in a foldable or trifold configuration for facilitating its carrying. When needed, supporting structure 810 is unfolded and ready for providing the needed supporting case to transform screen-expandable smartphone 700 into a tablet.

FIG. 9 is a block diagram of an exchangeable smartphone 900 comprising an extended housing structure 901 (with the dimensions of 160.3×225×8.5 mm), an extended touchscreen 902 (with a display size of 9.64 inches), a first compartment 903 situated therein a pocket-sized smartphone 904, and additional compartments for storing an extended battery 906, an extended audio IC (integrated circuit) 907, an extended touchscreen IC 908, flat OP connector 909A, and display/camera flat OP connector 910A. Extended touchscreen 902 is rendered engageable in circuit connection with pocket-sized smartphone 904 to become a tablet.

Pocket-sized smartphone 904 has a built-in display 905 with a size of 6.67 inches, flat OP ports 909B and 910B having the Operating Power Mode capable of establishing circuit connection with extended touchscreen IC 908 for carrying high-resolution video and audio signals. Alternatively, as depicted in FIG. 9, extended touchscreen IC 908 has a FFC ribbon 911 connecting to a display/camera flat OP port 910B in circuit connection with a system bus 912 of pocket-sized smartphone 904. FFC ribbon 911 utilizes preferably a MIPI DSI-2 (Display Serial Interface) protocol for data transfer between an APU 940 (applications processing unit) and extended touchscreen 902.

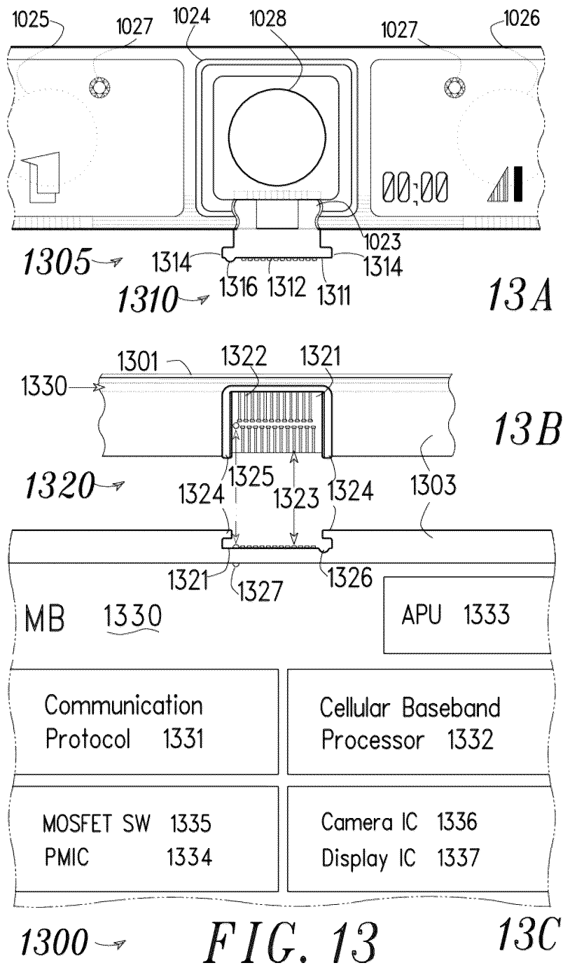

Flat OP ports 909B and 910B are engaged with flat OP connector 909A and display/camera flat OP connector 910A respectively. These flat ports and connectors are integrated with conductive pins/legs in a surface or flat type to be further detailed in FIG. 13.

In essence, comprised in pocket-sized smartphone 904 is a mainboard 919 that contains a communication protocol 920, a cellular baseband processor 930, APU 940, and a PMIC (power management integrated circuit) 950. Communication protocol 920 includes RF transceiver 921, GPS 922, NFC (Near Field Communication) 923, BT (Bluetooth) 924, Wi-Fi 925, cellular antenna 926 and Wi-Fi antenna 927. Cellular baseband processor 930 comprises chipsets such as AFE (analog front-end module) 931, MCU (Microcontroller Unit embedded with flash memory) 932, DSP (digital signal processing) 933, and ROM/RAM (non-volatile and volatile memory) 934 for managing and controlling the raw, low-frequency baseband signals in various communication functions including signal generation, modulation, demodulation, as well as data transmission over wireless networks.

RF transceiver 921 relies on AFE (analog front-end module) 931 that comprises a set of circuit blocks for processing analog signals before conversing into digital signals. GPS 922 may not necessarily require going through AFE 931, if being software-based, or still use AFE 931 for signal acquisition and tracking. BT 924 and Wi-Fi 925 are processed by APU 940, without requiring cellular baseband 930.

Comprised in APU 940 are MCU 941, ROM/RAM 943, and ISP (image signal processor) 944 for interacting audio IC 945, camera IC 948 (referring to external camera module 421 as depicted in FIG. 4) , screen.1 IC 946 (internal), and screen.2 IC 947 (associated with external or extended touchscreen 908). APU 940 may be in a form of SoC/SiP (System-on-Chip and/or System-in-Package) 942. Embedded on SoC/SiP 942 or ROM/RAM 943 are control algorithm or instructions for selectively switching an active display between built-in display 905 and extended touchscreen 902. The instructions include (i) if not detecting any signal from display/camera flat OP port 910B or system bus 912, screen.1 IC 946 and thus built-in display 905 remain active for pocket-sized smartphone 904 to function as a standalone unit, and (ii) when detecting a signal via display/camera flat OP port 910B or system bus 912 issued from extended touchscreen IC 908, actuating screen.2 IC 947 and deactuating screen.1 IC 946 and thus built-in display 905, so as to actuate the function of extended touchscreen 902.

PMIC 950 has a power source of battery 951, extended battery 906, wired flat OP port 909B and WCS (wireless charging system) 959. PMIC 950 is implemented with analog and digital functions (voltage regulation, current scaling, control logic, realtime clocking, power sequencing, battery management, DC-DC conversions, communication interfacing) and with MOSFET SW (Metal-Oxide-Semiconductor Field-Effect Transistor Switches) 952 for selectively providing LDO (Low Drop-Out) RF 953, LDO analog 954, LDO digital 955, LDO screen.1 956, LDO screen.2 957, and LDO camera 958 to communication protocol 920, cellular baseband processor 930, and APU 940 through power and control buses 913-915 respectively. Also provided are power and control buses 916-918 for PMIC 950 to selectively actuate audio IC 945, camera IC 948, screen.1 IC 946, screen.2 IC 947, extended Audio IC 907, and wired flat OP port 909B.

Further, APU 940 rendered to detect the presence of camera modules 221-223, 421, 520 (FIGS. 2-5) by detecting a clock signal for instance by a SPI (Serial Peripheral Interface) protocol. Without the presence of the camera modules, PMIC 950 will not actuate LDO camera 958 for outputting power. Thus, the conductive pins/legs on port connector 418 or 419 (FIG. 4), port connector 518 or 519 (FIG. 5), and port connector 612 (FIG. 6) are protected from water-caused short circuit. Consequently, exchangeable smartphones, camera modules and extended touchscreens recited in the primary preferred embodiments are implemented.

Preferably, PMIC 950 and control algorithm or instructions embedded on SoC/SiP 942 are rendered to allow camera module 222 to take advanced selfies and camera modules 221 and 223 to take wide angle and telephoto photography, so that a portrait is taken by accompanying with its front-facing surrounding scenery in real life. That is the self-portrait is in a particular visual perception of a scenery in real time.

While embodied on an exchangeable smartphone with extendable touchscreen, the illustrations hereinabove are also applicable to further elaborate the first and the second primary preferred embodiments depicted in FIGS. 2-6 focusing on advancing an accessory camera unit for extended photography capabilities alone.

In summary, the third primary preferred embodiment as recited in FIGS. 7-9 provides a smartphone with expendable/extendable touchscreen capabilities. The smartphone is rendered to have at least one display compartment for storing an unrollable touchscreen. Alternatively implemented is an accessory touchscreen unit containing an external display IC module engageable by a pocket-sized smartphone with a PMIC rendered capable of distributing operating power through the port to the external display IC module. Further provided is a control algorithm comprising instructions of (i) detecting if the port should be actuated, (ii) if to be actuated, instructing the PMIC to provide operating power to the port, (iii) if operating power is actuated, establishing circuit communication between the smartphone and the display IC module, and (iv) deactuating the built-in display of the pocket-sized smartphone, if a request to actuate the accessory touchscreen is detected.

### Advanced Camera Unit With Multiple Front-facing and Rear-facing Cameras

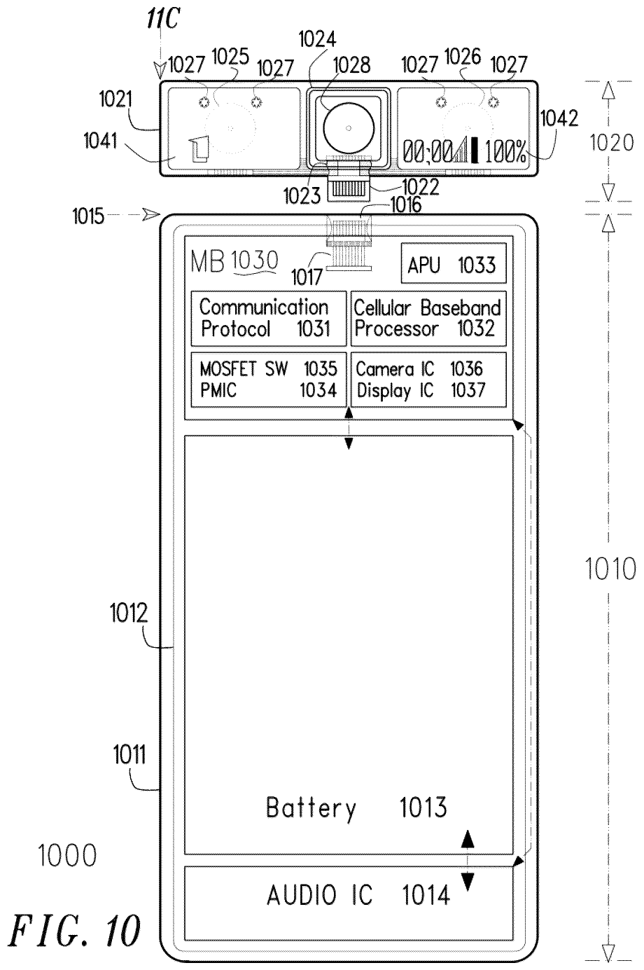

The fourth primary preferred embodiment is depicted in FIG. 10, illustrating an accessory camera unit rendered to have multiple front-facing and rear-facing camera modules. FIG. 10 depicts a mixed perceptive and block view of an exchangeable smartphone 1000 rendered to comprise a non-camera smartphone 1010 (i.e., a smartphone without any built-in camera) and an advanced camera unit 1020 removable and engageable to each other for providing advanced camera functionalities.

Non-camera smartphone 1010 contains a smartphone housing structure 1011 therein situated with a display 1012, a battery 1013, an audio IC 1014, a top side 1015 rendered to have a port 1016, and a MB (mainboard) 1030 having system bus 1017 connected to port 1016, but preferably without any built-in camera.

MB 1030 comprises a communication protocol 1031, a cellular baseband processor 1032, an APU 1033 comprising instructions, and a PMIC 1034 having MOSFET SW 1035 for controlling operating power to camera IC 1036 and display IC 1037. The functionalities of these components are similar to the description elaborated in FIG. 9. MOSFET SW 1035 deactuates port 1016 to prevent from possible water damage.

Advanced camera unit 1020 is stably supported by port 1016 on top side 1015 through a camera housing structure 1021 sustained or upheld by a male connector 1022. Further contained in camera housing structure 1021 are a front-facing camera module 1024 and two rear-facing camera modules 1025 and 1026 (depicted in dots) each with two flashes 1027. Front-facing camera module 1024 and rear-facing camera modules 1025 and 1026 have respective lens modules (for instance 1028) arranged in a lens plane parallel with display 1012, as depicted in FIG. 10.

A pivot 1023 is further provided so as to allow advanced camera unit 1020 rotatable about male connector 1022 to a maximal degree of 180 preferably, capable of switching rear-facing camera module 1028 to become a new front-facing camera for taking selfies or live broadcasting with advanced features and functionalities.

Pivot 1023 may be replaced by another male connector for plugging into camera housing structure 1021, becoming a separated structure removable from both advanced camera unit 1020 and non-camera smartphone 1010. Alternatively, male connector 1022 is formed into an integrated part of camera housing structure 1021. Nonetheless, port 1016 structurally functions as a supporting port adapted to support male connector 1022 that stably sustains or upholds camera housing structure 1021 on top side 1015, so as to render front-facing camera module 1024 and rear camera modules 1025 and 1026 capable of standing stably while taking photos or videos.

While two rear camera modules 1025 and 1026 are depicted in dots, more or less rear camera modules are feasible so as to cover all of advanced normal, macro, wide angle, ultrawide angle, and telephoto modes.

Further provided are instructions executable by APU 1033 or MCU 941 for (i) taking a front (or self-portrait) image and rear images (or photos) in normal, macro, wide angle, ultrawide angle, and telephoto modes simultaneously; (ii) saving the front and the images; (iii) combining the front and the rear images in one frame in a desirable configuration, so that the self-portrait is accompanying with the surrounding scenery in real life simultaneously; (iv) applying AI technology to automatically extract the main portrait from the front image; and (v) applying AI technology to integrate the extracted self-portrait image onto the surrounding rear images in various modes.

Port 1016 and male connector 1022 are rendered engageable for their respective conductive pins to establish operating power connection as well as camera interface. Without containing any built-in camera, non-camera smartphone 1010 is thus capable of freeing up valuable space for either increasing battery capacity or upgrading other functionalities. Further, an engageable camera interface port such as port 1016 and male connector 1022 allows an owner to have a choice of upgrading or replacing a different advanced camera unit if necessary.

Further comprised in camera housing structure 1021 is a mini display 1041 and 1042 functioning as always-on status bars showing time, messages, banners, mobile network, Wi-Fi, battery level, and any of other notifications. The instructions executable by APU 1033 further comprise the steps of (i) instructing PMIC 1034 and MOSFET SW 1035 to distribute keep-alive power to a display IC module contained in mini display 1041 and 1042, and (ii) deactuating operating power to display 1012.

Preferably, the conductive pins/legs of the connectors and the adapters exemplified in FIGS. 2-10 comprise power line capable of distributing sufficient wattages necessary for the operation of an accessory camera unit and/or extended touchscreen.

Referring now to FIG. 9, the detailed exemplary illustration of power distributing of FIG. 10 is further elaborated hereinafter. PMIC 950 is rendered to designate the needed voltages and amperages controlled by MOSFET SW 952 through LDO screen.2 957 and LDO camera 958 for distribution to the conductive power pins/legs sufficient for operating the recited accessory camera unit and/or extended touchscreen. Preferably, MOSFET SW 952 is made of NMOS (N-channel Metal-Oxide-Semiconductor) for less power consumption and faster switching. MCU 941 situated in APU 940 comes with features of GPIO (General Purpose Input/Output) capable of interfacing PMIC 950 and MOSFET SW 952 for customizing signals in controlling sensors, actuators, lights, and various power outputs through power and control buses 916-918. For circuitry using FET (Field-Effect Transistors), Vdd power pins provide positive supply voltage from 1.2V to 5V to digital logic gates and Vss power pins set a stable ground reference at 0V. Further used is a 1.2 or 1.8V rail, instead of a 3.3V rail to reduce battery power consumption.

Preferably, the Vdd power pins above 1.2V (such as Vusb pin normally 5V and Vbat pin from a back battery) are deactuated for preventing possible water-caused short circuit on a display/camera flat OP port 910B. In contrast, a conventional USB-C port always supplies +5V Vbus.

When detecting an actuating signal, PMIC 950 and MOSFET SW 952 will actuate LDO camera 958 or LDO screen.2 957, for instance, from a 1.2V rail, followed by a 1.8V rail and then a 3.3V rail to selectively power on camera IC 948 or screen.2 IC 947 to be distributed exemplarily to camera modules depicted in FIGS. 2-9 or extended touchscreen 908, respectively.

Further preferred is to categorize the recited power pins into an operating rail and a keep-alive rail. The operating rail may be 5V, 3V3, and/or 1V 8 as long as designed sufficiently for the operations of the recited camera modules or the extended touchscreen, i.e., in the actuated or active mode. On the other hand, the keep-alive rail provides less power just sufficient for sensing, detecting or monitoring the power-on or the power-on reset (POR). POR keeps the recited camera modules or the extended touchscreen static until LDO camera 958 or LDO screen.2 957 reach a threshold voltage so as to guarantee their initialization in a known state after the operating rail is applied.

Alternatively, the actuating and deactuating of the conductive pins is performed by a trigger microswitch as recited in FIG. 6, instead of always providing keep-alive power to the keep-alive rail.

In summary, the fourth primary preferred embodiment depicted in FIG. 10 provides an advanced camera unit having multiple front-facing and rear-facing camera modules. Detailed power distributions and circuit connections are recited in FIG. 9. Further provided are instructions executable by a MCU or APU for (i) taking multiple photos including self-portrait and rear images in normal, macro, wide angle, ultrawide angle, and/or telephoto modes simultaneously; (ii) saving the front and the images; (iii) combining the front and the rear images in one frame in a desirable configuration, so that the self-portrait image is accompanying with the surrounding scenery in real life simultaneously; (iv) applying AI technology to automatically extract the main portrait from the front image; and (v) applying AI technology to integrate the extracted self-portrait in the surrounding rear images in various modes. Further recited in power distributing are the steps of control algorithm executable by the MCU/APU for instructing the PMIC to perform (i) actuating the first (or operating) power supply and the second (or keep-alive) power supply to be respectively provided to the main touchscreen and the mini display, and (ii) deactuating the first power supply to the main touchscreen, while retaining the second power supply for the mini display to stay alive; so as to extend the smartphone with advanced display capabilities.

### U-Shaped Connectors

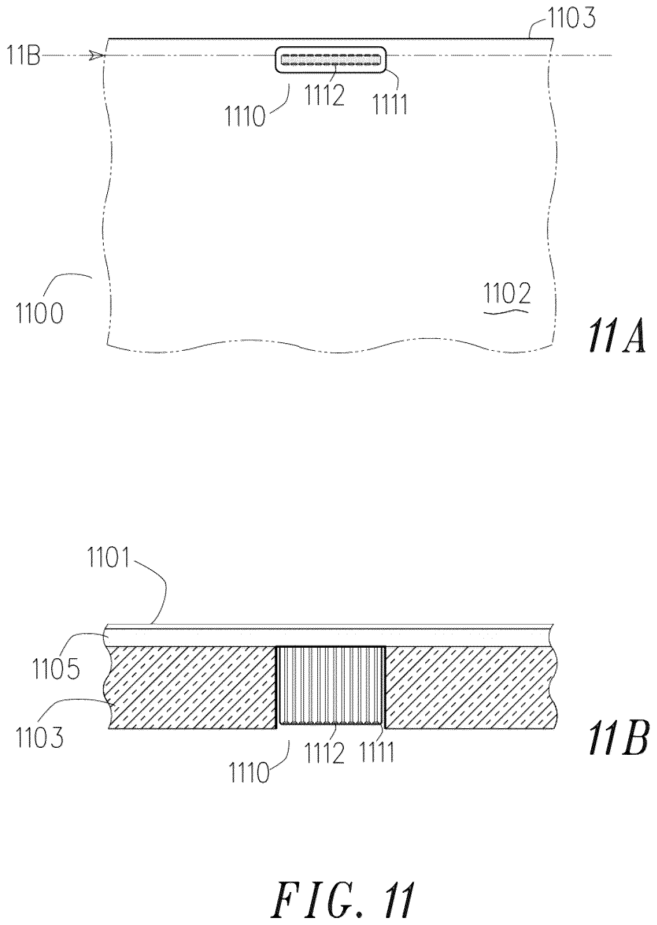

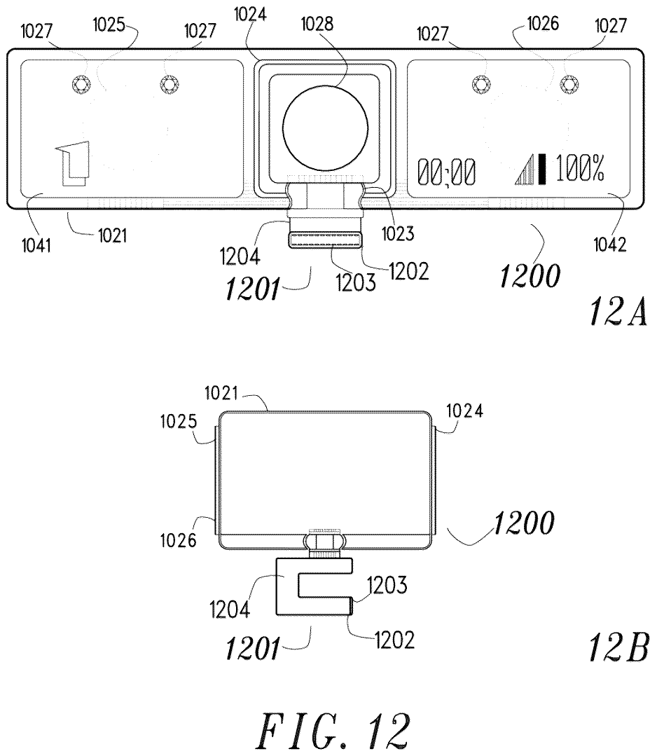

The fifth primary preferred embodiment of the present invention is illustrated in FIGS. 11 and 12. FIG. 11 depicts a female port suitable for engaging with a U-shaped connector shown in FIG. 12. Referring to FIGS. 11, 11A depicts a horizontal port 1110 engageable from the back side 1102 (or back cover) of a non-camera smartphone 1100. 11B portrays the cross-sectional view of horizontal port 1110 along the plane of 11B parallel with top face 1103 seen in 11A. The cross-sectional view shows horizontal port 1110 having female port 1111 and male conductive pins 1112, both seen in 11A and 11B.

As seen from the top view of the top side, 11B is currently a horizontal cross-sectional view of horizontal port 1110, which is perpendicular to a main display 1101. Horizontal port 1110 is a female port 1111 that has male conductive pins 1112 in power and circuit connection with a MB 1105 as shown in 11B. Furthermore, horizontal port 1110 is just next to the top face 1103, which is a top side of the midframe of non-camera smartphone 1100.

In accordance with the fifth primary preferred embodiment, further provided is an accessory camera unit 1200 shown in FIG. 12. Accessory camera unit 1200 has a U-shaped connector depicted in a front view 12A and a side view 12B. Front view 12A shows accessory camera unit 1200 having component labels identical to those situated in camera housing structure 1021 of advanced camera unit 1020, except for the U-shaped connector 1201 different from male connector 1022 seen in FIG. 10.

U-shaped connector 1201 seen in 12A is a male connector 1202 with female conductive pins 1203, to be plugged into horizontal port 1110 depicted in FIG. 11. Male connector 1202 and its female conductive pins 1203 are currently horizontal and parallel with top face 1103 as depicted in FIG. 11. While male connector 1202 is perpendicular to main display 1101 seen in FIG. 11, U-shaped connector 1201 has a supporting column 1204 for vertically supporting accessory camera unit 1200 with respect to top face 1103 of non-camera smartphone 1100 seen in FIG. 11.

U-shaped connector 1201 is made in a precise manner so as to render accessory camera unit 1200 further rotatable and stable while seating on top face 1103 as seen in FIG. 11. A side view of 12A is shown in 12B, depicting rear-facing camera modules 1025 and 1026 on the left and front-facing camera module 1024 on the right. Pivot 1023 in 12A also allows accessory camera unit 1200 rotatable in a horizontal plane perpendicular to main display 1101, and parallel with top face 1103 as seen in FIG. 11. Both are in complete contrast to the conventional flip-out smartphones and the prior art including Kinouchi.

In summary, the fifth primary preferred embodiment illustrated in FIGS. 11 and 12 provides a U-shaped connector engageable with a horizontal port situated parallel with top side of a smartphone, which has a supporting column for stably upholding an accessory camera unit with advanced photography capabilities.

### Surface-Type Ports and Connectors for Facilitating the Engaging of Conjugated Conductive Pins

The sixth primary preferred embodiment is shown in FIG. 13, illustrating the snap-on mechanism of a surface-type port and a surface-type connector implemented into a non-camera smartphone 1300 in a cutaway view. Depicted in FIG. 13 are 13A showing a surface-type connector 1310 and an accessory camera unit 1305 engaged to each other, 13B showing a top view of a surface-type port 1320, and 13C showing a side view (from the back side) of surface-type port 1320.

As shown in 13A, surface-type connector 1310 is rotatably engaged with accessory camera unit 1305 by pivot 1023. Accessory camera unit 1305 has components labeled with 10XX are referring identically to advanced camera unit 1020 seen in FIG. 10, except for surface-type connector 1310 that has an engaging surface 1311, front conductive pins 1312 situated on surface 1321, and a pair of tongues 1314.

13B depicts front conductive pins 1322 and rear conductive pins 1323 alternately arranged in two rows on the top side 1303 of non-camera smartphone 1300, which are generally facing a similar or same direction. The alternately configured conductive pins prevent any improper short circuit from happening during engaging and disengaging. Front conductive pins 1322 seen in 13B to be engaged with front conductive pins 1312 seen in 13A, so that the front-facing camera module 1024 as shown in 13A and main display 1301 seen in 13B are facing in the same direction.

Engaging surfaces 1311 and 1322 as well as front and rear conductive pins 1322 and 1323 are perpendicular to main display 1301, in contrast to parallel aligning direction of the conductive pins/legs on port connectors 518 and 519 (FIG. 5) and port connector 612 (FIG. 6). Due to the fact that both surface-type connector 1310 and surface-type port 1320 each is in a single surface, their snap-on engagement requires no space in between as compared to the plug-in action required by USB-OP 706 and USB-OP connector 806 seen in FIG. 8 for engaging pocket-sized smartphone 700 to extended case 800.

Both front conductive pins 1322 and rear conductive pins 1323 are in operating power and circuit connection with MB 1330 seen in 13B as well as 13C. Surface-type port 1320 has two holding grooves 1324 for tightly holding a pair of tongues 1314. Surface-type connector 1310 has a guiding tongue 1316 for ensuring a directional engagement to a guiding groove 1326 seen in 13C. Further provided is an external water-proof trigger microswitch 1325 for selectively actuating an internal trigger microswitch 1327 on MB 1330 for a power draw from MOSFET SW 1335 if needed, so that front and rear conductive pins 1322 and 1323 carry no operating or even standby power if disengaged.

In essence, surface-type port 1320 and surface-type connector 1310 are adapted to have (a) a groove-and-tongue structure for directional conjugated engaging and holding, and (b) an engaging surface generally parallel with perpendicular to main display 1301. Conductive pins 1322 and 1323 are further arranged in a configuration selected from the group consisting of (i) a first layout, wherein the conductive pins are arranged in a single row; (ii) in a second layout, wherein the conductive pins are alternately arranged on engaging surface 1321 in at least two rows facing a same or a similar direction, and (iii) a third layout, wherein the conductive pins are placed on a surface generally perpendicular to engaging surface 1321, and (iv) any of their combinations.

MB 1330 comprises communication protocol 1331, cellular baseband processor 1332, APU 1333, PMIC 1334, camera IC 1336, and display IC 1337. Their functionalities are identical to the descriptions respectively recited for communication protocol 920, cellular baseband processor 930, APU 940, PMIC 950, camera IC 948, and screen.1 IC 946 previously recited in FIG. 9.

While the terminology of “surface-type” is used for simplified illustration, it generally refers to any flat, curved, waved, or bended surface for the recited surface-type connectors and ports as long as the conductive pins/legs are arranged in a manner to face a same side or a similar direction, unlike the conventional USB ports or HDMI connectors having pins arranged in two opposite rows.

Furthermore, while all of front conductive pins 1312 and 1322 as well as rear conductive pins 1313 (not seen in 13A) and 1323 depicted in FIG. 13 are placed on engaging surfaces 1311 and 1321 perpendicular to main display 1301, these pins may be placed on another pin surface parallel to main display 1301. In other words, the pin surface is perpendicular to engaging surfaces 1311 and 1321 to be engaged to each other. Under the scenario, the engaging surfaces are still perpendicular to main display 1301 identical to 13B. This pin-surface-perpendicular-to-engaging-surface mechanism still utilizes holding grooves 1324, tongues 1314, and guiding tongue 1316 for enabling a precision engaging without requiring the pins placed in the alternate-arranged configuration as depicted in 13B. However, the pin-surface-perpendicular-to-engaging-surface mechanism will take away some space from non-camera smartphone, as compared to the pins-on-engaging-surface mechanism depicted in 13B.

In summary, the sixth primary preferred embodiment recites (a) surface-type port 1320 or connector 1310 is adapted (i) to have an engaging surface aligned parallel to a side of a smartphone and generally perpendicular to the main touchscreen, and (ii) to have a groove-and-tongue structure for directional conjugated engaging and holding; and (b) the conductive pins are arranged in a configuration selected from the group consisting of (i) a first layout, wherein the conductive pins are arranged in a single row; (ii) a second layout, wherein the conductive pins are arranged on the engaging surface alternately in at least two rows facing a similar direction, and (iii) a third layout, wherein the conductive pins are placed on a surface generally perpendicular to the engaging surface, and (iv) any of their combinations.

### Smartphones Rendered to Have Keep-Alive Mini Displays

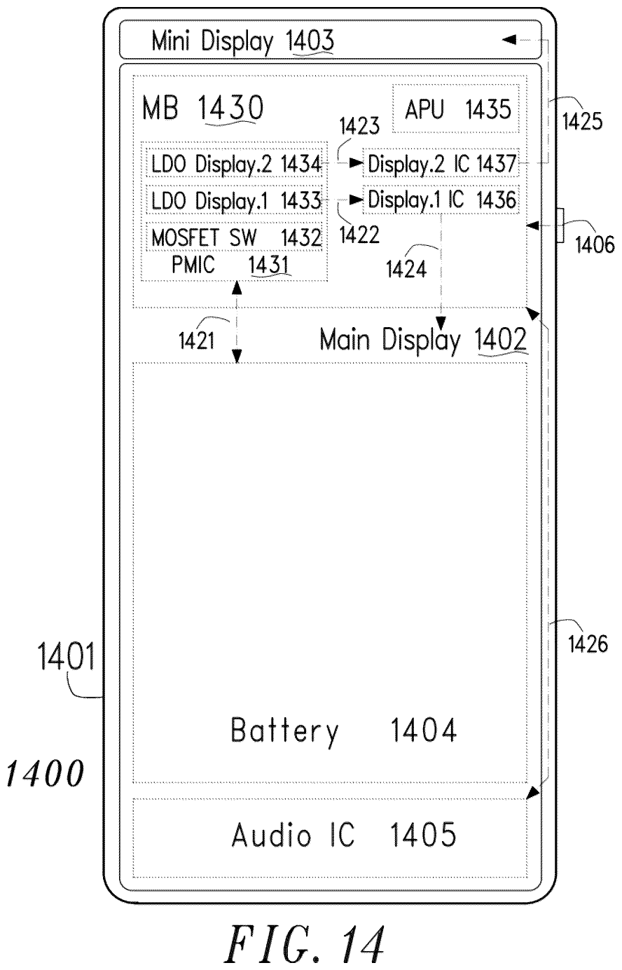

The seventh primary preferred embodiment is depicted in FIG. 14, reciting a smartphone 1400 rendered to have a keep-alive mini display to replace the conventional status bar, for showing time, messages, banners, mobile network, Wi-Fi, and/or battery level. In complete contrast, the conventional status bar is known to be present only together with the actuation of the built-in touchscreen of a conventional smartphone.

FIG. 14 is a simplified block diagram focusing on illustration of configuring keep-alive power to enable a mini display or zone to be always on for achieving the purposes of convenience and energy conserving. Smartphone 1400 comprises a housing structure 1401 with its front side covered by a stationary main display 1402 and a mini display 1403, a battery 1404, an audio IC 1405, a MB 1430 situated thereon a PMIC 1431 and an APU 1435, as well as power and circuit buses 1421-1426.

APU 1435 contains microcontroller and control algorithm executable for controlling the operation of PMIC 1431, which comprises MOSFET SW 1432 selectively actuatable for providing LDO display.1 1433 and LDO display.2 1434 respectively. The control algorithm designates LDO display.1 1433 as operating power to display.1 IC 1436 then to main display 1402 via buses 1422 and 1424, while LDO display.2 1434 as keep-alive power to display.2 IC 1437 then to mini display 1403 via buses 1423 and 1425, respectively.

One push of a power button 1406 interacts MB 1430 for requesting APU 1435 to turn on or off LDO display.1 1433 for actuating or deactuating the supply of operating power to main display 1402 that is in a standby mode, while the keep-alive power supplied from LDO display.2 1434 to display.2 IC 1437 and thus to mini display 1403 remains operational. Accordingly, the seventh primary preferred embodiment enables mini display 1403 functioning as an always-on status bar for showing time, weather, messages, banners, mobile network, Wi-Fi, battery level, emails, and any of their combinations, without turning on main display 1402. Mini display 1403 may be further turned off, if receiving a designated button signal selected from the group consisting of a short push signal, a long push signal, a double-push signal, a multiple-push signal, and any of their combinations selectively from a power button and/or a volume button.

Preferably, mini display 1403 in keep-alive power and circuit communication with display.2 IC 1437 is rendered capable of detecting a long press for turning off the status bar, instead of the two-push power-button approach.

While depicted main display 1402 and mini display 1403 in separate pieces constructed on the same front face having the same facing direction, FIG. 14 also represents a single OLED/AMOLED/LCD display panel split into the main display and the mini display for the embodiment as long as two display IC modules (recited as 1436 and 1437) are provided and connected to the OLED/AMOLED/LCD display panel that is divided into a keep-alive display zone as mini display 1403 and a normal display zone relied on the presence of operating power as main display 1402. The embodiment of constructing separated pieces of screens faced in a same or similar direction is also recited in FIGS. 2, 4, 10, and 13.

Alternatively, less efficient is to provide an algorithm for dimming the main display. The power consumption of mini display 1403 is ignorable because of its ignorable size that also does not require high refreshing rates or resolutions.

Further, mini display 1403 is rendered to detect a signal for actuating LDO display.1 1433 for providing operating power to display.1 IC 1436 and thus main display 1402. The signal may be a swipe action or a long touching or pressing. This feature will further conserve power consumed possibly by the conventional practice that has to maintain power readily available to (i) a built-in touchscreen for its ultrasonic fingerprint sensor especially situated under display, for fingerprint recognition to unlock, (ii) a built-in front camera for facial detection for facial recognition, (iii) a swipe-type fingerprint sensor for the entire built-in touchscreen, (iv) a motion sensor present in an accelerometer for monitoring or identifying various motions such as orientation, tilting, shaking, and rotation, (v) an exemplary digital accelerometer ADXL345, for measuring/detecting XYZ acceleration, activity, or double taps. Those sensors may cause misbehavior leading to undesired actuation and unintended operation, from accidental screen touching, moving, tilting, vibrating, shaking, and/or swinging even unless a front-facing camera does not sense any light.

Accordingly, the seventh primary preferred embodiment eliminates the need of keeping the various sensors alive required in the conventional latest smartphones having under-display fingerprint and other motion-activated sensors just for resuming the operating mode. Especially, the present invention will not invoke main display 1402 as well as mini on display 1403 just from any finger touching, long-holding, tapping, or motion-incurred misbehaviors, unless a long-press signal on mini display 1403 is detected. Thus, FIG. 14 avoids any unwanted screen-touching behavior and battery draining.

The long-press signal is provided only as an example for illustration. A double-push power button may also be used to reactuate the operating power to main display 1402. In essence, mini display 1403 may be rendered responsive for actuating the operating power be provided to main display 1402, if mini display 1403 receives a designated signal selected from the group consisting of a double touching, a long touching press, a double-pressing signal, a double-tap signal, a swiping signal, a multiple-tap signal, and any of their combinations. Similarly, any push or combinations of power and/or volume buttons may be also used to selectively actuate or deactuate the mini display.

The terminology of keep-alive power is given hereinabove only for facilitating illustration. It refers generally to a second power supply distributed to mini display 1403 for keeping its functionalities alive, in order to conserve the unnecessary consumption of operating power that may be also called as a first power supply.

Further preferred is to render display.2 IC 1437 capable of being selectively deactuated for hiding the status bar or being interfaced with display.1 IC 1436 so as to allow mini display 1403 to join main display 1402 together for exhibiting an image in one whole frame without any distraction from the conventional status bar and a under-display front camera.

In summary, the seventh primary preferred embodiment is to enable advanced display and/or photography capabilities to a smartphone having a battery and a mainboard situated thereon a PMIC and an APU or MCU. The method comprises: (a) configuring the PMIC capable of providing a first power supply and a second power supply; (b) providing power distributions on the mainboard for the first power supply to a main touchscreen and for the second power supply to a mini display; (c) control algorithm executable by the smartphone for instructing the PMIC to perform steps of (i) actuating the first power supply and the second power supply respectively to the main touchscreen and the mini display, (ii) deactuating the first power supply to the main touchscreen, while retaining the second power supply alive to the mini display; so as to extend the smartphone with advanced display capabilities; and (iii) rendering the mini display capable of actuating the main touchscreen, only when receiving a designated touching signal from the mini display or from a power and/or a volume button.

Furthermore, the combination of these seven primary preferred embodiments recites structural configurations, power distributing arrangements and control instructions for extending a smartphone with advanced photography and displaying capabilities as well as extendable, removable and exchangeable functionalities. A smartphone will be rendered with these exemplary advanced capabilities and functionalities, when configured to comprise: (a) an accessory camera unit comprising at least one camera IC module, at least one camera lens having an optical axis, and a camera port having conductive pins in operating power and circuit connection with the at least one camera IC module; (b) a phone housing structure assembled with a touchscreen having a display plane, a battery, a mainboard comprising a PMIC and an APU comprising a MCU, and a phone port having conductive legs in operating power and circuit connection respectively with the PMIC and the mainboard; (c) an upholding structure having a supporting column, a top connector and a bottom connector interconnected with conductive lines, wherein (i) the top connector and the bottom connector are rendered engageable to the camera port and to the phone port, respectively, (ii) the supporting column is situated in a perpendicular manner with respect to a side of the phone housing structurer, when upholding the accessory camera unit, so as to place the optical axis at least in an orientation generally perpendicular to the display plane for the accessory camera unit to function selectively as at least one front-facing camera and/or at least one rear-facing camera; (iii) the conductive lines are furnished for establishing operating power and circuit connection between the mainboard and the at least one camera IC module; and (d) a control algorithm installed and/or embedded onto the motherboard, executable by the APU or MCU for (i) actuating the PMIC to supply an operating power supply from the battery to the phone port, (ii) interfacing the at least one camera IC module for retrieving images obtained therefrom, and (iii) transmitting the images for displaying on the touchscreen. Further comprised in the smartphone is a trigger switch incorporated into the supporting port, selectively for actuating or deactuating operating power in the absence of keep-alive power.

### Control Algorithm for Enabling Advanced Camera And/or Display Functionalities

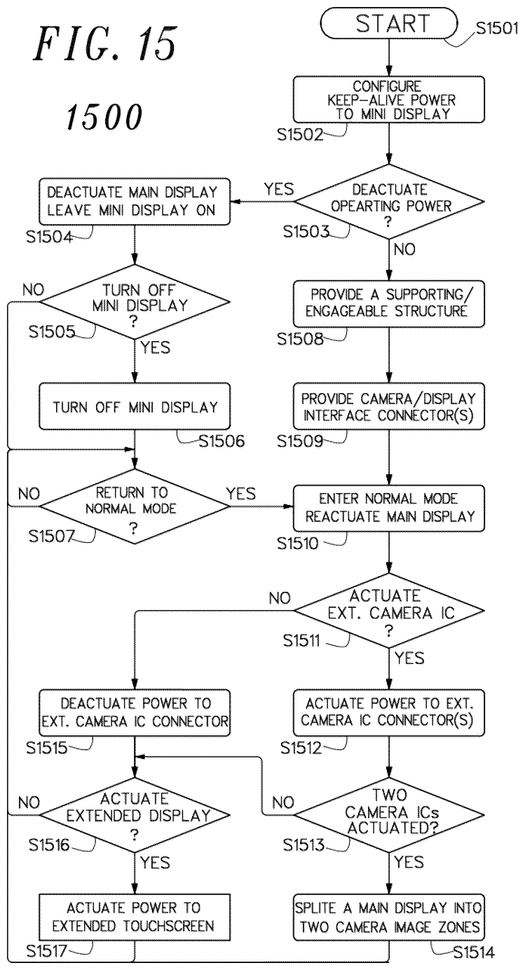

The eighth primary preferred embodiment illustrates the control algorithm or the operating method stored in APU 1033 in FIG. 10, APU 1435 in FIG. 14, or embedded/installed on SoC/SiP 942, MCU 941, and/or ROM/RAM 943 in FIG. 9. The algorithm is recited as a flowchart depicted in FIG. 15, comprising steps, instructions, or processes, in accordance with a seventh primary preferred embodiment of the present invention.

Method 1500 starts with Step S1501. Note that “S” stands for “Step” hereinafter. S1502 configures the PMIC of an exchangeable smartphone to provide LDO keep-alive power especially arranged to a separate mini display or a mini display zone for the purposes of showing exemplarily a status bar in an energy-conserving mode and of confining a limited and small zone for receiving an effective wake-up touching signal as expressively recited in FIG. 14.

S1503 detects if operating power to a main display is to be deactuated. If yes, S1504 deactuates the operating power to the main display, while leaving keep-alive power on for the mini display. This allows the exchangeable smartphone to turn off the main display completely, while enables the mini display to function as an always-on status bar for showing time, weather, messages, banners, mobile network, Wi-Fi, and/or battery level, without turning on the main display just for checking any new message, weather condition, or battery level. S1503 further disables the conventional practice of maintaining the entire touchscreen touch-sensitive in order for a conventional under-display fingerprint sensor always readily active to receive a wake-up signal for fingerprint recognition as well as for a front camera module fully available for facial recognition.

S1505 detects if the mini display is to be turned off. If yes, followed is S1506, in which the mini display may remain capable of detecting a long press or a double-press signal for waking up the mini display itself and/or the main display. If no, S1507 is followed for determining if it should return to the normal mode. If yes, S1510 is followed, in which operating power to the main display is reactuated.

Further provided in method 1500 is a step of S1508, providing supporting/engageable structures exemplified as rotation connectors 231-233 in FIGS. 2 and 3, port 417 in FIG. 4, port 517 in FIG. 5, port 611 in FIG. 6, and USB-OP 706 and supporting structure 810 in FIG. 8, to be respectively engaged with rotation connectors 231-233 in FIGS. 2 and 3, male rotation connector 427 in FIG. 4, male rotation connector 527 in FIG. 5, male connector 630 in FIG. 6, USB-OP connector 806 and supporting structure 810 in FIG. 8, the supporting/engageable structural pair of port 1016 and male connector 1022 in FIG. 10, the horizontal port and the U-shaped connector in FIGS. 11 and 12, as well as the surface-type port and connector in FIG. 13 for the applications of connecting to accessory camera modules or extendable/extended touchscreens.

In essence, S1508 provides a supporting structural configuration to a smartphone, so as to render an accessory camera unit removable/rotatable or an extended touchscreen capable of being stably upheld as depicted in FIGS. 2-13. S1509 further provides camera/display interface ports and connectors having conductive pins for supplying operating power to and for establishing circuit connection with accessory camera units or extended display modules. As exemplarily embodied in FIGS. 2-13, the interface ports and the connectors with conductive pins are further integrated into their respective supporting/engageable structures.

S1510 enters into a normal mode, i.e., actuating operating power and thus turning on the main display. S1511 detects or determines if an external or extended camera IC is present or to be actuated. The presence or the actuating of camera IC or ICs at S1511 may be exemplarily embodied by receiving camera serial interface clock signals therefrom or power requests from the connections of male adapters (428 in FIGS. 4, 528 in FIGS. 5, 631 in FIG. 6, and 1016 in FIG. 10) and port connectors (418 and 419 in FIGS. 4, 518 and 519 in FIGS. 5, 612 in FIG. 6, and 1016 in FIG. 10), as well as trigger microswitch 616 in FIG. 6 or 1325 in FIG. 13. The trigger microswitch mechanism allows selectively actuating or deactuating operating power in the absence of keep-alive power.

If yes, followed is S1512 to actuate operating power sufficiently to power ext. (external) camera IC as exemplarily recited in FIGS. 10 and 13 without relying on bulkily carrying and adding an external DC power supply. Thus, S1512 renders the engaged accessory camera modules or units convenient and functionable as if built in internally. If no, camera IC connector is deactuated S1515. As depicted in FIG. 9 exemplarily, APU 940 instructs PMIC 950 to deactuate LDO camera 958 to connector 511 and thus port connectors 518 and 519 in FIG. 5, port connector 612 in FIG. 6, or port 1016 in FIG. 10 for preventing water damage if any. Preferably provided is a trigger microswitch 616 in FIG. 6 or 1325 in FIG. 13, so as to completely cease the supplying of any power to the external conductive pins.

S1513 determines if there are two camera IC modules to be actuated. If yes, S1514 splits the main display into at least two camera image zones respectively representing the views obtained from at least two camera modules, as exemplarily recited in FIG. 3, so as to allow a user to make any necessary adjustment for taking photos in various advanced photographic scenarios or modes simultaneously.

If no two camera ICs determined at S1513, S1516 may be further executed to determine if there is an extended display/touchscreen to be actuated. If yes, operating power to extended touchscreen is actuated S1517 for the embodiments recited in FIGS. 8 and 9, and deactuates built-in display 905 depicted in FIG. 9. If no, the process goes back to S1507 to determine if to return to the normal mode. The process goes back to S1507 determining if to return to the normal mode. If no, S1507 is repeated till determining to return to the normal mode at S1510.

In summary, the eighth primary preferred embodiment recites an operating method for extending advanced photography and/or display capabilities to a smartphone having a battery and a mainboard situated thereon a PMIC and a MCU, by: (a) configuring the PMIC capable of providing a first power supply and a second power supply; (b) providing power distributions for the first power supply to a main touchscreen and/or an accessory camera unit, and for the second power supply to a mini display; and (c) control algorithm executable by the MCU for (i) actuating the first power supply and the second power supply respectively to the main touchscreen and/or the accessory camera unit and to the mini display, and (ii) deactuating the first power supply to the main touchscreen and/or the accessory camera unit, while retaining the second power supply alive to the mini display; so as to extend the smartphone with advanced photography and/or display capabilities. Further, the algorithm comprises instructions of (i) detecting if the built-in conductive pins should be actuated, (ii) if to be actuated, instructing the PMIC to provide the operating power supply to the built-in conductive pins, (iii) if the operating power supply is actuated, establishing circuit communication between the mainboard and the external IC module through the supporting port, (iv) deactuating the display, if detecting a request to actuate an extended/expanded touchscreen, (v) deactuating the operating power supply, (vi) providing keep-alive power selectively for sensing, detecting or monitoring the state of the external IC module, and/or for enabling a mini display to show the status of the smartphone, and (vii) splitting the display into at least two image zones each for showing a view from a camera module.

Finally, it is clearly understood that such embodiments are provided by way of illustration and example only and are not to be taken by way of limitation as numerous variations, changes, modification, omissions, adaptations and/or alterations, combinations and substitutions will occur to those skilled in the art without departing from the invention herein. Furthermore, the steps of the processes and/or the methods disclosed in the examples may be modified in any manner, including by reordering steps and/or inserting or deleting steps. Accordingly, it is intended that the invention be limited only by the spirit and scope of the appended claims1.1

1. A smartphone with advanced photography capabilities, comprising:
(a) an accessory camera unit comprising at least one camera IC module, at least one camera lens having an optical axis, and a camera port having conductive pins in power and circuit connection with said at least one camera IC module;
(b) a phone housing structure assembled with a built-in touchscreen having a display plane, a battery, a mainboard comprising a PMIC (power management IC) and an APU (applications processing unit), and a phone port having conductive legs in power and circuit connection respectively with said PMIC and said mainboard for outputting external power and for establishing external circuit connection thereto;
(c) an upholding structure having a supporting column, a top connector and a bottom connector interconnected with conductive lines, wherein (i) said top connector and said bottom connector are rendered engageable to said camera port and to said phone port, respectively, (ii) said supporting column is situated in a perpendicular manner with respect to a side or a back side of said phone housing structurer, when upholding said accessory camera unit, so as to place said optical axis at least in an orientation generally perpendicular to said display plane for said accessory camera unit to function selectively as at least one front-facing camera and/or at least one rear-facing camera; (iii) said conductive lines are furnished for establishing power and circuit connection between said mainboard and said accessory camera unit; and
(d) a control algorithm installed and/or embedded onto said motherboard, executable by said APU for (i) actuating said PMIC to provide said external power selectively with an operating power supply and/or a keep-alive power supply from said battery to said phone port, (ii) in accordance with a determination when said operating power supply is provided, interfacing said at least one camera IC module for retrieving images obtained therefrom, and (iii) transmitting said images for displaying on said built-in touchscreen.

2. The smartphone of claim 1, wherein said top connector is rendered unremovable but rotatable once engaged to said camera port, while said bottom connector is selectively engageable or disengageable to said phone port.

3. The smartphone of claim 1, wherein said accessory camera unit further comprises a mini display generally parallel with said optical axis, and wherein said control algorithm further comprises (i) a step of instructing said PMIC to provide said keep-alive power supply to said mini display, in accordance with a determination when said mini display is placed in the same facing orientation as said display plane, and when said operating power supply to said built-in touchscreen is deactuated; and (ii) another step of displaying a status bar of said smartphone on said mini display.

4. The smartphone of claim 1, wherein said accessory camera unit is rendered to have a longer side for situating said optical axis aligned in parallel, so as to allow said at least one camera lens to have a longer focal length and/or a larger camera lens size.

5. The smartphone of claim 1, wherein said control algorithm comprises (i) splitting said built-in touchscreen into at least two image zones each for showing a view generated from a camera IC module, if detecting that said accessory camera unit contains at least two camera IC modules to be actuated; and (ii) allowing a user to view said at least two image zones for taking at least two photos simultaneously.
